(19) United States
(12) Patent Application Publication
(10) Pub. No.: US 2023/0227654 A1
(43) Pub. Date: Jul. 20, 2023

(54) FAST DRYING ASPHALT COMPOSITIONS WITH IMPROVED PERFORMANCE AT LOWER ASPHALT RESIDUE

(71) Applicant: BASF SE, Ludwigshafen am Rhein (DE)

(72) Inventor: Kostas S. AVRAMIDIS, Charlotte, NC (US)

(21) Appl. No.: 18/126,502

(22) Filed: Mar. 27, 2023

Related U.S. Application Data
(62) Division of application No. 16/064,574, filed on Jun. 21, 2018.
(60) Provisional application No. 62/270,266, filed on Dec. 21, 2015.

(51) Int. Cl. C08L 95/00; C08L 9/08; C08L 11/02; C08L 23/08; C08L 25/10

(52) U.S. Cl. CPC C08L 95/005; C08L 9/08; C08L 11/02; C08L 23/0853; C08L 25/10; C08K 2003/3081

(57) ABSTRACT

Disclosed herein are asphalt compositions. In some embodiments, the asphalt compositions can include asphalt, a polymer, and a basic salt such as aluminum sulfate. In some embodiments, the asphalt compositions can include asphalt, a polymer, and an inorganic acid such as phosphoric acid. The asphalt compositions can include asphalt in an amount of from 50 wt % to 99.9 wt %, based on the weight of the asphalt composition. In some embodiments, the asphalt compositions can include a styrene-butadiene copolymer in an amount of from 0.05 wt % to 10 wt %, based on the weight of the asphalt composition. The basic salt can be present in an amount of from 0.01 wt % to 5 wt %, based on the weight of the asphalt compositions. The acid can be present in an amount of from 0.005 wt % to 0.1 wt %, based on the weight of the asphalt compositions. Methods of making and using the asphalt compositions are also disclosed.

### CROSS-REFERENCE TO RELATED APPLICATIONS

This application claims the benefit of and priority to U.S. patent application Ser. No. 62/270,266 filed on Dec. 21, 2015, the disclosure of which is expressly incorporated herein by reference in its entirety.

### FIELD OF THE DISCLOSURE

This disclosure relates generally to asphalt compositions, and more particularly to asphalt compositions that include an asphalt modifier, and to methods of making and using the asphalt compositions.

### BACKGROUND OF THE DISCLOSURE

Asphalt compositions have a wide number of applications, including but not limited to the production of aggregate pavement. The properties of asphalt may be improved by the incorporation of a polymer. The addition of the polymer can improve adhesion, ductility, tensile strength, and cold temperature properties of the asphalt. Polymer modified asphalt compositions can be prepared by melting the asphalt and adding a polymer to the molten asphalt. However, this process is energy intensive. Alternately, polymer modified asphalt compositions can be prepared by mixing emulsions of asphalts with a latex of the polymer. While this process is less energy intensive, it increases the delay in setting times and drying times of asphalt emulsions. This delay is extremely expensive when traffic must be kept off a lane of a high way for a lengthy period of time. Another problem encountered is that the asphalt emulsion may get too fluid and can separate from the aggregate. There is a need for asphalt compositions with increased drying times, setting times, and viscosity. The compositions and methods described herein address these and other needs.

### SUMMARY OF THE DISCLOSURE

Disclosed herein are asphalt compositions. In some embodiments, the asphalt compositions can include an asphalt emulsion, such as a cationic asphalt emulsion. Methods of making and using the asphalt compositions are also disclosed.

In some embodiments, the asphalt compositions can include asphalt, a polymer, and a basic salt such as aluminum sulfate. In some embodiments, the asphalt compositions can include asphalt, a polymer, and an acid such as phosphoric acid. In some embodiments, the asphalt compositions do not include a thickener. The asphalt compositions can include asphalt in an amount of from 50 wt % to 99.9 wt %, from 50 wt % to 95 wt %, or from 60 wt % to 80 wt %, based on the weight of the asphalt composition. In some embodiments, the asphalt composition is an asphalt emulsion comprising, asphalt, a polymer, a basic salt such as aluminum sulfate, and water. In some embodiments, the asphalt composition (e.g., the asphalt emulsion) is cationic. In some embodiments, the asphalt composition is a cationic asphalt emulsion comprising asphalt, a polymer, and phosphoric acid, wherein the cationic asphalt emulsion does not include a thickener. In some embodiments, the asphalt composition is a hot mix asphalt composition comprising, asphalt, a polymer, a basic salt such as aluminum sulfate, and water. The hot mix asphalt composition can further include a sulfur curing agent

The asphalt compositions can include a polymer selected from styrene-butadiene copolymers, polychloroprene, styrene-butadiene-styrene block copolymers, ethylene vinyl acetate copolymers, styrene acrylic copolymers, pure acrylic polymers, vinyl acrylic copolymers, and combinations thereof. In some embodiments, the polymer can include a styrene-butadiene copolymer. The asphalt compositions can include the polymer in an amount of from 0.05 wt % to 10 wt %, based on the weight of the asphalt composition. In some embodiments, the asphalt compositions can include the polymer in an amount of from 0.5 wt % to 5 wt %, based on the weight of the asphalt composition. In some embodiments, the polymer in the asphalt compositions can be in the form of an aqueous polymer dispersion (also referred to herein as a latex composition). The aqueous polymer dispersion can further include a sulfur curing agent.

The basic salt can be present in the asphalt compositions in an amount of from 0.01 wt % to 5 wt % or from 1 wt % to 2 wt %, based on the weight of the asphalt compositions. In some embodiments, the basic salt can be present in an amount, such that the pH of the asphalt composition is from 5 to 8.

The asphalt compositions can include an acid selected from hydrochloric acid, phosphoric acid, sulfuric acid, polyphosphoric acid, citric acid, tartaric acid, and combinations thereof. In some embodiments, the asphalt compositions can include phosphoric acid. The acid can be present in an amount of from 0.005 wt % to 0.1 wt %, based on the weight of the asphalt composition.

The asphalt compositions can further include an aggregate.

The viscosity of the asphalt compositions can be 100 cp or greater. In some embodiments, when the asphalt composition is an asphalt emulsion comprising an asphalt solids content of at least 65 wt %, based on the weight of the asphalt composition, the asphalt composition has a viscosity of from 100 to 2500 cp at 60° C. using a Brookfield viscometer, spindle #3, at 20 rpm. In some embodiments, when the asphalt composition is a hot mix asphalt composition comprising an asphalt solids content of at least 95 wt %, based on the weight of the asphalt composition, the asphalt composition has a viscosity of from 1000 to 3000 cp at 60° C. using a Brookfield viscometer, spindle #3, at 20 rpm. In some embodiments, the asphalt composition (e.g., the asphalt emulsion) including the phosphoric acid can have a softening point that is 5° C. or greater than the softening point of the same asphalt composition without the phosphoric acid.

In some embodiments, the asphalt compositions are asphalt emulsions and can include droplets. The droplets can have a median particle size of from 3 to 15 μm and a standard deviation of from 3 to 30 μm.

Methods of making the asphalt compositions are also disclosed. The method can include mixing asphalt, a polymer, and one or more of a basic salt and an inorganic acid. In some embodiments, the method can include mixing asphalt, an aqueous dispersion including a polymer, and aluminum sulfate to form an asphalt composition, wherein the aluminum sulfate is present in an amount of from 0.01 wt % to 5 wt %, based on the weight of the asphalt composition. In some embodiments, the method can include contacting an anionic or nonionic aqueous latex composition comprising a polymer with phosphoric acid to form a cationic latex composition, mixing the cationic latex composition, asphalt and optionally water to form a mixture, wherein the mixture has a viscosity of from 100 to 2500 cp at 60° C. using a Brookfield viscometer, spindle #3 at 20 rpm when the mixture comprises an asphalt solids content of 65% by weight, based on the weight of the mixture, wherein the mixture does not comprise a thickener.

Methods of coating a surface comprising applying an asphalt compositions as described herein to the surface are also disclosed herein.

### BRIEF DESCRIPTION OF THE DRAWINGS

The accompanying drawings, which are incorporated in and constitute a part of this specification, illustrate several embodiments of the disclosure and together with the description, serve to explain the principles of the disclosure.

FIG. 1 is a bar graph showing the moisture loss and aggregate loss of a styrene-butadiene polymer-modified asphalt emulsion (control) and a styrene-butadiene polymer-modified asphalt emulsion containing aluminum sulfate (Example 1).

FIG. 2 is a bar graph showing the moisture loss and aggregate loss of a styrene-butadiene polymer-modified asphalt emulsion (control 2) and a phosphoric acid flipped styrene-butadiene polymer-modified asphalt emulsion containing aluminum sulfate (Example 2).

FIG. 3 is a bar graph showing the moisture loss and aggregate loss of a phosphoric acid flipped styrene-butadiene polymer-modified asphalt emulsion (Example 3) and a phosphoric acid flipped styrene-butadiene polymer-modified asphalt emulsion containing aluminum sulfate (Example 2).

FIG. 4 is a graph showing the particle size distribution of the styrene-butadiene polymer-modified asphalt emulsions exemplified in FIG. 3.

FIG. 5 is a bar graph showing the moisture loss and aggregate loss of phosphoric acid flipped styrene-butadiene polymer-modified asphalt emulsions at low asphalt contents (Examples 3 and 5).

FIG. 6 is a graph showing the particle size distribution of the styrene-butadiene polymer-modified asphalt emulsions exemplified in FIG. 5.

FIG. 7 is a bar graph showing the moisture loss and aggregate loss of a styrene-butadiene polymer-modified asphalt emulsion (control 3) and phosphoric acid flipped styrene-butadiene polymer-modified asphalt emulsions with varying levels of cationic surfactant (Examples 6-8).

FIG. 8 is a graph showing the particle size distribution of the styrene-butadiene polymer-modified asphalt emulsions exemplified in FIG. 7.

FIG. 9 is a bar graph showing the moisture loss and aggregate loss of a phosphoric acid flipped styrene-butadiene polymer-modified asphalt emulsion (Example 2) and a phosphoric acid flipped styrene-butadiene polymer-modified asphalt emulsion containing polyphosphoric acid (Example 8).

### DETAILED DESCRIPTION

The term “comprising” and variations thereof as used herein is used synonymously with the term “including” and variations thereof and are open, non-limiting terms. Although the terms “comprising” and “including” have been used herein to describe various embodiments, the terms “consisting essentially of” and “consisting of” can be used in place of “comprising” and “including” to provide for more specific embodiments and are also disclosed. As used in this disclosure and in the appended claims, the singular forms “a”, “an”, “the”, include plural referents unless the context clearly dictates otherwise. The disclosure of percentage ranges and other ranges herein includes the disclosure of the endpoints of the range and any integers provided in the range.

Disclosed herein are asphalt compositions. In some embodiments, the asphalt composition can include asphalt, a polymer, and a basic salt such as aluminum sulfate. In some embodiments, the asphalt composition can include asphalt, a polymer, and an inorganic acid such as phosphoric acid. Methods of making and using the compositions described herein are also disclosed.

The term “asphalt” as used herein, includes the alternative term “bitumen.” Thus, the asphalt compositions can be termed bitumen compositions. “Asphalt composition” as used herein, include asphalt emulsions and hot-mix asphalt compositions. The asphalt can be molten asphalt. The asphalt compositions can include 50% or greater by weight of the asphalt compositions, of asphalt. In some embodiments, the asphalt compositions can include 55% or greater, 60% or greater, 65% or greater, 70% or greater, 75% or greater, 80% or greater, 85% or greater, 90% or greater, 95% or greater, or 99% or greater by weight of the asphalt compositions, of asphalt. In some embodiments, the asphalt compositions can include 99.9% or less, 99% or less, 95% or less, 90% or less, 87% or less, 85% or less, 83% or less, or 80% or less by weight of the asphalt compositions, of asphalt. In some embodiments, the asphalt compositions can include 50% to 99.9%, 50% to 95%, 50% to 90%, 50% to 85%, 50% to 80%, 60% to 95%, 60% to 90%, or 60% to 80% by weight of the asphalt compositions, of asphalt.

As described herein, the asphalt compositions can include a polymer. In some embodiments, the polymer can be derived from ethylenically unsaturated monomers. For example, the polymer can be a pure acrylic polymer (i.e., a polymer derived exclusively from (meth)acrylate and/or (meth)acrylic acid monomers), a styrene-butadiene copolymer (i.e., a polymer derived from butadiene and styrene monomers), a styrene-butadiene-styrene block copolymer, a vinyl aromatic-acrylic copolymer (i.e., a polymer derived from vinyl aromatic monomers such as styrene and one or more (meth)acrylate and/or (meth)acrylic acid monomers), a vinyl-acrylic copolymer (i.e., a polymer derived from one or more vinyl ester monomers and one or more (meth)acrylate and/or (meth)acrylic acid monomers), a vinyl chloride polymer (i.e., a polymer derived from one or more vinyl chloride monomers), a vinyl alkanoate polymer (i.e., a polymer derived from one or more vinyl alkanoate monomers, such as polyvinyl acetate or a copolymer derived from ethylene and vinyl acetate monomers), or a combination thereof. The term “(meth)acryl . . . ,” as used herein, includes “acryl . . . ,” “methacryl . . . ,” or mixtures thereof. The polymer can be a random copolymer or a block copolymer. In some embodiments, the polymer can include a styrene-butadiene copolymer, polychloroprene, a styrene-butadiene-styrene block copolymer, an ethylene vinyl acetate copolymer, a styrene acrylic copolymer, an acrylic polymer, a vinyl acrylic copolymer, or a combination thereof.

Suitable unsaturated monomers for use in forming the polymer are generally ethylenically unsaturated monomers and include vinylaromatic compounds (e.g. styrene, a-methylstyrene, o-chlorostyrene, and vinyltoluenes); 1,2-butadiene (i.e. butadiene); conjugated dienes (e.g. 1,3-butadiene and isoprene); α,β-monoethylenically unsaturated mono- and dicarboxylic acids or anhydrides thereof (e.g. acrylic acid, methacrylic acid, crotonic acid, dimethacrylic acid, ethylacrylic acid, allylacetic acid, vinylacetic acid maleic acid, fumaric acid, itaconic acid, mesaconic acid, methylenemalonic acid, citraconic acid, maleic anhydride, itaconic anhydride, and methylmalonic anhydride); esters of α,β-monoethylenically unsaturated mono- and dicarboxylic acids having 3 to 6 carbon atoms with alkanols having 1 to 12 carbon atoms (e.g. esters of acrylic acid, methacrylic acid, maleic acid, fumaric acid, or itaconic acid, with C₁-C₁₂, C₁-C₈, or C₁-C₄ alkanols such as ethyl, n-butyl, isobutyl and 2-ethylhexyl acrylates and methacrylates, dimethyl maleate and n-butyl maleate); acrylamides and alkyl-substituted acrylamides (e.g. (meth)acrylamide, N-tert-butylacrylamide, and N-methyl(meth)acrylamide); (meth)acrylonitrile;

vinyl and vinylidene halides (e.g. vinyl chloride and vinylidene chloride); vinyl esters of C1-C18 mono- or dicarboxylic acids (e.g. vinyl acetate, vinyl propionate, vinyl n-butyrate, vinyl laurate and vinyl stearate); C₁-C₄ hydroxyalkyl esters of C₃-C₆ mono- or dicarboxylic acids, especially of acrylic acid, methacrylic acid or maleic acid, or their derivatives alkoxylated with from 2 to 50 moles of ethylene oxide, propylene oxide, butylene oxide or mixtures thereof, or esters of these acids with C₁-C₁₈ alcohols alkoxylated with from 2 to 50 mol of ethylene oxide, propylene oxide, butylene oxide or mixtures thereof (e.g. hydroxyethyl (meth)acrylate, hydroxypropyl (meth)acrylate, and methylpolyglycol acrylate); and monomers containing glycidyl groups (e.g. glycidyl methacrylate).

The polymer can include on more additional monomers. The additional monomers can include, for example, other vinyl aromatic compounds (e.g., α-methylstyrene, o-chlorostyrene, and vinyltoluene); isoprene; anhydrides of ocfl-monoethylenically unsaturated monocarboxylic and dicarboxylic acids (e.g., maleic anhydride, itaconic anhydride, and methylmalonic anhydride); other alkyl-substituted acrylamides (e.g., N-tert-butylacrylamide and N-methyl(meth)acrylamide); vinyl and vinylidene halides (e.g., vinyl chloride and vinylidene chloride); vinyl esters of C₁-C₁₈ monocarboxylic or dicarboxylic acids (e.g., vinyl acetate, vinyl propionate, vinyl N-butyrate, vinyl laurate, and vinyl stearate); C₁-C₄ hydroxyalkyl esters of C₃-C₆ monocarboxylic or dicarboxylic acids, for example of acrylic acid, methacrylic acid, or maleic acid, or their derivatives alkoxylated with from 2 to 50 moles of ethylene oxide, propylene oxide, butylene oxide or mixtures thereof, or esters of these acids with C₁-C₁₈ alcohols alkoxylated with from 2 to 50 mol of ethylene oxide, propylene oxide, butylene oxide or mixtures thereof (e.g., hydroxyethyl (meth)acrylate, hydroxypropyl (meth)acrylate, and methylpolyglycol acrylate); monomers containing glycidyl groups (e.g., glycidyl methacrylate); linear 1-olefins, branched-chain 1-olefins or cyclic olefins (e.g., ethene, propene, butene, isobutene, pentene, cyclopentene, hexene, and cyclohexene); vinyl and allyl alkyl ethers having 1 to 40 carbon atoms in the alkyl radical, wherein the alkyl radical can possibly carry further substituents such as a hydroxyl group, an amino or dialkylamino group, or one or more alkoxylated groups (e.g., methyl vinyl ether, ethyl vinyl ether, propyl vinyl ether, isobutyl vinyl ether, 2-ethylhexyl vinyl ether, vinyl cyclohexyl ether, vinyl 4-hydroxybutyl ether, decyl vinyl ether, dodecyl vinyl ether, octadecyl vinyl ether, 2-(diethylamino)ethyl vinyl ether, 2-(di-N-butylamino)ethyl vinyl ether, methyldiglycol vinyl ether, and the corresponding allyl ethers); sulfo-functional monomers (e.g., allylsulfonic acid, methallylsulfonic acid, styrenesulfonate, vinylsulfonic acid, allyloxybenzenesulfonic acid, 2-acrylamido-2-methylpropanesulfonic acid, and their corresponding alkali metal or ammonium salts, sulfopropyl acrylate, and sulfopropyl methacrylate); vinylphosphonic acid, dimethyl vinylphosphonate, and other phosphorus monomers (e.g., phosphoethyl (meth)acrylate); alkylaminoalkyl (meth)acrylates or alkylaminoalkyl(meth)acrylamides or quatemization products thereof (e.g., 2-(N,N-dimethylamino)ethyl (meth)acrylate, 3⁻(N,N-dimethylamino)propyl (meth)acrylate, 2-(N,N,N-trimethylammonium)ethyl (meth)acrylate chloride, 2-dimethylaminoethyl(meth)acrylamide, 3-dimethylaminopropyl(meth)acrylamide, and 3-trimethylammoniumpropyl(meth)acrylamide chloride); allyl esters of Ci-C3o monocarboxylic acids; N-vinyl compounds (e.g., N-vinylformamide, N-vinyl-N-methylformamide, N-vinylpyrrolidone, N-vinylimidazole, 1-vinyl-2-methylimidazole, 1-vinyl-2-methylimidazoline, N-vinylcaprolactam, vinylcarbazole, 2-vinylpyridine, and 4-vinylpyridine); monomers containing 1,3-diketo groups (e.g., acetoacetoxyethyl (meth)acrylate or diacetone acrylamide); monomers containing urea groups (e.g., ureidoethyl (meth)acrylate, acrylamidoglycolic acid, and methacrylamidoglycolate methyl ether); monoalkyl itaconates; monoalkyl maleates; hydrophobic branched ester monomers; monomers containing silyl groups (e.g., trimethoxysilylpropyl methacrylate), vinyl esters of branched mono-carboxylic acids having a total of 8 to 12 carbon atoms in the acid residue moiety and 10 to 14 total carbon atoms such as, vinyl 2-ethylhexanoate, vinyl neo-nonanoate, vinyl neo-decanoate, vinyl neo-undecanoate, vinyl neo-dodecanoate and mixtures thereof, and copolymerizable surfactant monomers (e.g., those sold under the trademark ADEKA REASOAP). In some embodiments, the one or more additional monomers include (meth)acrylonitrile, (meth)acrylamide, or a mixture thereof. In some embodiments, the polymer can include the one or more additional monomers in an amount of greater than 0% to 10% by weight, based on the weight of the polymer. For example, the polymer can include the one or more additional monomers in an amount of 0.5% to 10%, 0.5% to 5%, 0.5% to 4%, 0.5% to 3%, 0.5% to 2%, or 0.5% to 1% by weight, based on the weight of the polymer.

The polymer can include one or more crosslinking monomers. Exemplary crosslinking monomers include N-alkylolamides of ogfi-monoethylenically unsaturated carboxylic acids having 3 to 10 carbon atoms and esters thereof with alcohols having 1 to 4 carbon atoms (e.g., N-methylolacrylamide and N-methylolmethacrylamide); glycidyl (meth)acrylate; glyoxal based crosslinkers; monomers containing two vinyl radicals; monomers containing two vinylidene radicals; and monomers containing two alkenyl radicals. Other crosslinking monomers include, for instance, diesters of dihydric alcohols with α,β-monoethylenically unsaturated monocarboxylic acids, of which in turn acrylic acid and methacrylic acid can be employed. Examples of such monomers containing two non-conjugated ethylenically unsaturated double bonds can include alkylene glycol diacrylates and dimethacrylates, such as ethylene glycol diacrylate, 1,3-butylene glycol diacrylate, 1,4-butylene glycol diacrylate and propylene glycol diacrylate, divinylbenzene, vinyl methacrylate, vinyl acrylate, allyl methacrylate, allyl acrylate, diallyl maleate, diallyl fumarate, methylenebisacrylamide, and mixtures thereof. In some embodiments, the polymer can include from 0.01% to 5% by weight of the polymer, of the crosslinking agent.

In some embodiments, the polymer in the asphalt composition can include styrene, butadiene, and optionally, one or more additional monomers. The styrene can be in an amount of 2% or greater by weight, based on the weight of the polymer. For example, the styrene can be in an amount of 5% or greater, 10% or greater, 20% or greater, 30% or greater, 40% or greater, 50% or greater, 60% or greater, or 70% or greater, by weight, based on the weight of the polymer. In some embodiments, the styrene can be in an amount of 95% or less, 90% or less, 85% or less, 80% or less, 75% or less, 70% or less, 65% or less, 60% or less, 55% or less, 50% or less, 45% or less, 40% or less, 35% or less, 30% or less, or 25% or less, by weight, based on the weight of the polymer. The butadiene can be in an amount of 2% by weight of the polymer. For example, the butadiene can be in an amount of 5% or greater, 10% or greater, 20% or greater, 30% or greater, 40% or greater, 50% or greater, 60% or greater, or 70% or greater by weight, based on the weight of the polymer. In some embodiments, the butadiene can be in an amount of 95% or less, 90% or less, 85% or less, 80% or less, 75% or less, 70% or less, 65% or less, 60% or less, 55% or less, 50% or less, 45% or less, 40% or less, 35% or less, 30% or less, or 25% or less, by weight, based on the weight of the polymer. In some embodiments, the weight ratio of styrene to butadiene monomers in the polymer can be from 1:99 to 99:1, from 20:80 to 80:20, from 30:70 to 70:30, or from 40:60 to 60:40. For example, the weight ratio of styrene to butadiene can be 25:75 or greater, 30:70 or greater, 35:65 or greater, or 40:60 or greater.

The styrene butadiene copolymer can include a carboxylic acid monomer. In some embodiments, the polymer can include a carboxylated styrene-butadiene copolymer derived from styrene, butadiene, and a carboxylic acid monomer. In some embodiments, the polymer can be derived from 0.5%-10%, 1-9%, or 2-8% by weight of a carboxylic acid monomer. Suitable carboxylic acid monomers include (meth)acrylic acid, itaconic acid, fumaric acid, or mixtures thereof. In some embodiments, the polymer can include a non-carboxylated styrene-butadiene copolymer (i.e., not derived from a carboxylic acid monomer). In some embodiments, the polymer includes one or more of the other monomers provided above.

In some embodiments, the polymer in the asphalt composition can be a styrene-butadiene copolymer. Suitable commercially available styrene-butadiene copolymers can include BUTONAL® NX1118, BUTONAL® NX 1138, BUTONAL® NX 4190, and BUTONAL® NS 198, commercially available from BASF Corporation.

The polymer in the asphalt compositions can be in an amount of 0.25% or greater by weight, based on the weight of the asphalt composition. In some embodiments, the asphalt composition can include the polymer in an amount of 0.25% or greater, 0.5% or greater, 0.75% or greater, 1% or greater, 1.5% or greater, 2% or greater, 2.5% or greater, 3% or greater, 3.5% or greater, 4% or greater, 4.5% or greater, 5% or greater, 6% or greater, 7% or greater, 8% or greater, or 9% or greater by weight, based on the weight of the asphalt composition. In some embodiments, the asphalt composition can include the polymer in an amount of 10% or less, 8% or less, 7% or less, 6% or less, 5% or less, 4% or less, 3% or less, 2% or less, or 1% or less by weight, based on the weight of the asphalt composition. In some embodiments, the asphalt composition can include the polymer in an amount of 0.25% to 10%, 0.5% to 8%, 0.5% to 6%, 0.75% to 5%, or 0.75% to 4% by weight, based on the weight of the asphalt composition.

In some embodiments, the polymer can be in the form of a latex composition. The latex composition can be an aqueous dispersion including particles of the polymer dispersed in water. In some embodiments, the latex composition can be prepared with a total solids content of from 5% to 90% by weight, for example, 10% to 80% by weight, 20% to 70% by weight, 25% to 65% by weight, 35% to 60% by weight, or 45% to 60% by weight, based on the weight of the latex composition. In some embodiments, the latex composition can have a total solids content of 40% or greater or 50% or greater by weight, based on the weight of the latex composition. In some embodiments, the latex composition can have a total solids content of 90% or less, 80% or less, or 70% or less by weight, based on the weight of the latex composition. The polymer particles in the latex composition can have an average particle size of from 20 nm to 500 nm, such as from 20 nm to 400 nm, from 30 nm to 300 nm, or from 50 nm to 250 nm. The particle size of the polymer particles can be measured using dynamic light scattering measurements, for example using a Nicomp Model 380 available from Particle Sizing Systems, Santa Barbara, CA.

The latex composition can be cationic, anionic, or non-ionic. In some embodiments, the latex composition can be cationic. For example, the latex composition can include a cationic surfactant such as an amine-containing surfactant at a suitable pH (e.g., below the pKa of the amine group in the cationic surfactant). In some embodiments, the latex composition can be anionic. For example, the latex composition can include a carboxylated polymer, such as a carboxylated styrene butadiene copolymer. In some embodiments, the latex composition (including the cationic, anionic, or non-ionic latex composition) can have a pH of 7 or less. For example, the latex composition can have a pH of 6.5 or less, 6 or less, 5.5 or less, 5 or less 4.5 or less 4 or less, or 3.5 or less. In some examples, the latex composition can have a pH of 2 or greater, 2.5 or greater, 3 or greater, 3.5 or greater, 4 or greater, 4.5 or greater, 5 or greater, 5.5 or greater, 6 or greater, 6.5 or greater, or 7 or greater. In some embodiments, the latex composition can have a pH of from 2 to 7, from 2 to 6.5, from 2 to 6, from 3 to 7, from 3 to 6.5, from 3 to 6, from 4 to 7, from 4 to 6.5, or from 4 to 6.

The latex composition can include one or more surfactants (emulsifiers) such as nonionic surfactants, anionic surfactants, cationic surfactants, amphoteric surfactants, or a mixture thereof. In some embodiments, the latex compositions include an amine derived surfactant. Suitable surfactants include polyamines, fatty amines, fatty amido-amines, ethoxylated amines, diamines, imidazolines, quaternary ammonium salts, and mixtures thereof. Examples of commercially available surfactants that can be used in the latex composition include those available from Akzo Nobel under the REDICOTE® trademark (such as REDICOTE® 4819, REDICOTE® E-64R, REDICOTE® E-5, REDICOTE® E-9, REDICOTE® E9A, REDICOTE® E-11, REDICOTE® E-16, REDICOTE® E-44, REDICOTE® E-120, REDICOTE® E-250, REDICOTE® E-2199, REDICOTE® E-4868, REDICOTE® C-346, REDICOTE® C-404, REDICOTE® C-450, and REDICOTE® C-471), surfactants available from MeadWestvaco under the INDULIN® and AROSURF® trademarks (such as INDULIN® 814, INDULIN® AMS, INDULIN® DF-30, INDULIN® DF-40, INDULIN® DF-42, INDULIN® DF-60, INDULIN® DF-80, INDULIN® EX, INDULIN® FRC, INDULIN® MQK, INDULIN® MQK-1M, INDULIN® MQ3, INDULIN® QTS, INDULIN® R-20, INDULIN® SBT, INDULIN® W-1, and INDULIN® W-5), ASFIER® N480 available from Kao Specialties Americas, CYPRO™ 514 available from Cytec Industries, polyethyleneimines such as those available from BASF under the POLYMIN® trademark (such as POLYMIN® SK, POLYMIN® SKA, POLYMIN® 131, POLYMIN® 151, POLYMIN® 8209, POLYMIN® P, and POLYMIN® PL), and polyvinylamines such as those available from BASF under the CATIOFAST® trademark (such as CATIOFAST® CS, CATIOFAST® FP, CATIOFAST® GM, and CATIOFAST® PL).

The latex composition can include an antioxidant to prevent oxidation of, for example, the double bonds of the styrene butadiene polymer. Suitable antioxidants can include substituted phenols or secondary aromatic amines. The composition can include antiozonants to prevent ozone present in the atmosphere from, for example, cracking the styrene butadiene polymer, by cleaving the double bonds of the styrene butadiene polymer. The latex composition can include prevulcanization inhibitors to prevent premature vulcanization or scorching of the polymer. Suitable antioxidants, antiozonants, and prevulcanization inhibitors are disclosed in U.S. Pat. No. 8,952,092. The antioxidants, antiozonants, and/or prevulcanization inhibitors can be provided in an amount from 1% to 5% by weight, based on the weight of the solids in the latex composition.

The latex compositions described herein can include an inorganic acid. In some embodiments, the latex compositions can include an inorganic acid selected from hydrochloric acid, sulfuric acid, phosphoric acid, polyphosphoric acid, C₁-C₁₄ organic acids such as acetic acid, formic acid, citric acid, tartaric acid, and mixtures thereof. In some embodiments, the inorganic acid can be present in an amount of from 0.3% to 3% by weight, based on the total weight of the latex composition. For example, the latex composition can include 0.3% or greater, 0.5% or greater, 1% or greater, 1.5% or greater, 2% or greater, or 2.5% or greater by weight of the latex composition, of the inorganic acid. In some embodiments, the latex composition can include 3% or less, 2.5% or less, 2.0% or less, 1.5% or less, 1.0% or less, or 0.5% or less by weight of the latex composition, of the inorganic acid. In some embodiments, the latex composition can include from 0.3% to 3%, 0.5% to 3%, or 1% to 3% by weight of the latex composition, of the inorganic acid. In some embodiments, the inorganic acid can be in an amount such that the pH of the latex composition or asphalt compositions thereof, can be from 1 to 6, such as from 2 to 4 or from 3 to 5. The inorganic acid can be present in an amount of from 0.005% to 0.1% by weight, based on the total weight of the asphalt composition.

In some embodiments, the latex composition can include phosphoric acid. In some embodiments, the latex compositions can include phosphoric acid and polyphosphoric acid. The amount of phosphoric acid in the latex composition can be 0.1% by weight or greater, based on the total weight of the latex composition. For example, the latex composition can include 0.2% or greater, 0.3% or greater, 0.5% or greater, 0.6% or greater, 0.7% or greater, 0.8% or greater, 0.9% or greater, 1% or greater, 1.5% or greater, 2% or greater, 2.5% or greater, or 3% or greater by weight of the latex composition, of phosphoric acid. In some embodiments, the latex composition can include 3% or less, 2.5% or less, 2% or less, 1.5% or less, or 1% or less by weight of the latex composition, of phosphoric acid. In some embodiments, the latex composition can include from 0.3% to 3%, 0.5% to 3%, or 1% to 3% by weight of the latex composition, of phosphoric acid.

The amount of phosphoric acid in the asphalt composition can be 0.005% by weight or greater, based on the total weight of the asphalt composition. For example, the asphalt composition can include 0.01% or greater, 0.02% or greater, 0.03% or greater, 0.04% or greater, 0.05% or greater, 0.06% or greater, 0.07% or greater, 0.08% or greater, 0.09% or greater, or 0.1% or greater by weight of the asphalt composition, of phosphoric acid. In some embodiments, the asphalt composition can include 0.1% or less, 0.09% or less, 0.08% or less, 0.07% or less, 0.06% or less, 0.05% or less, 0.04% or less, 0.03% or less, 0.02% or less, 0.01% or less, 0.009% or less, 0.008% or less, 0.007% or less, or 0.005% or less by weight of the asphalt composition, of phosphoric acid. In some embodiments, the asphalt composition can include from 0.005 to 0.1%, or 0.01% to 0.1% by weight of the asphalt composition, of phosphoric acid.

The amount of latex composition used to produce the asphalt composition can be in an amount of 0.5% or greater by weight, based on the weight of the asphalt composition. In some embodiments, the asphalt composition can include the latex composition in an amount of 1% or greater, 1.5% or greater, 2% or greater, 2.5% or greater, 3% or greater, 3.5% or greater, 4% or greater, 4.5% or greater, 5% or greater, 6% or greater, 7% or greater, 8% or greater, 9% or greater, 10% or greater, 11% or greater, 12% or greater, 13% or greater, or 14% or greater by weight, based on the weight of the asphalt composition. In some embodiments, the asphalt composition can include the latex composition in an amount of 15% or less, 12% or less, 10% or less, 8% or less, 7% or less, 6% or less, 5% or less, 4% or less, 3% or less, 2% or less, or 1% or less by weight, based on the weight of the asphalt composition. In some embodiments, the asphalt composition can include the latex composition in an amount of 0.5% to 15%, 0.5% to 12%, 0.5% to 10%, 1% to 15%, or 1% to 10% by weight, based on the weight of the asphalt composition.

The asphalt compositions can include a basic salt. Suitable basic salts can include the salt of a strong base and a weak acid. In some embodiments, the asphalt compositions can include a basic salt selected from sodium sulfate, potassium sulfate, magnesium sulfate, aluminum sulfate, iron sulfate, cobalt sulfate, barium sulfate, beryllium sulfate, copper sulfate, zinc sulfate, manganese sulfate, sodium carbonate, sodium bicarbonate, potassium carbonate, potassium bicarbonate, potassium sodium carbonate, sodium bisulfate, ammonium bisulfate, potassium bisulfate, potassium sulfite, sodium sulfite, potassium hydrogen sulfite, ammonium sulfite, disodium hydrogen phosphate, sodium dihydrogen phosphate, dipotassium hydrogen phosphate, and mixtures thereof. In some embodiments, the basic salt can include aluminum sulfate. The basic salt, such as aluminum sulfate, can be in an amount of 0.01% by weight or greater by weight, based on the weight of the asphalt compositions. In some embodiments, the asphalt compositions can include the basic salt in an amount of 0.05% or greater, 0.1% or greater, 0.25% or greater, 0.5% or greater, 0.75% or greater, 1% or greater, 1.5% or greater, 2% or greater, or 2.5% or greater by weight, based on the weight of the asphalt compositions. In some embodiments, the asphalt compositions can include the basic salt in an amount of 5% or less, 4% or less, 3% or less, 2% or less, 1.5% or less, 1% or less, or 0.5% or less by weight, based on the weight of the asphalt compositions. In some embodiments, the asphalt compositions can include the basic salt in an amount of 0.01% to 5%, 0.05% to 4%, 0.1% to 5%, 0.2% to 4%, or 0.3% to 3%, by weight, based on the weight of the asphalt compositions. The asphalt compositions can include the basic salt in an amount such that the pH of the asphalt compositions has a pH of from 1.5 to 10, such as from 1.5 to 6, from 8 to 10, or from 5 to 8.

The asphalt compositions described herein can be vulcanized or cured to crosslink the polymer included in the asphalt composition, thereby increasing the tensile strength and elongation of the polymer. In some embodiments, the asphalt compositions can include vulcanizing (curing) agents, vulcanization accelerators, antireversion agents, or a combination thereof. In some embodiments, the vulcanizing (curing) agents, vulcanization accelerators, antireversion agents, or a combination thereof can be included in the latex composition. In some embodiments, the vulcanizing agents, vulcanization accelerators, and/or antireversion agents can be included in the asphalt composition. Exemplary vulcanizing agents are sulfur curing agents and include various kinds of sulfur such as sulfur powder, precipitated sulfur, colloidal sulfur, insoluble sulfur and high-dispersible sulfur; sulfur halides such as sulfur monochloride and sulfur dichloride; sulfur donors such as 4,4′-dithiodimorpholine; selenium; tellurium; organic peroxides such as dicumyl peroxide and di-tert-butyl peroxide; quinone dioximes such as p-quinone dioxime and p,p′-dibenzoylquinone dioxime; organic polyamine compounds such as triethylenetetramine, hexamethylenediamine carbamate, 4,4′-methylenebis(cyclohexylamine) carbamate and 4,4′-methylenebis-o-chloroaniline; alkylphenol resins having a methylol group; and mixtures thereof. The vulcanizing agent can be present from 0.01 to 1% or from 0.01 to 0.6% by weight, based on the weight of the asphalt composition. In some embodiments, the asphalt compositions can include a sulfur containing curing agent such as sulfur dispersions or sulfur donors. In some embodiments, the sulfur containing curing agent can be included in the latex composition prior to including in the asphalt composition.

Exemplary vulcanization accelerators include sulfenamide-type vulcanization accelerators such as N-cyclohexyl-2-benzothiazole sulfenamide, N -t-butyl-2-benzothiazole sulfenamide, N-oxyethylene-2-benzothiazole sulfenamide, N-oxydiethylene-2-benzothiazole sulfenamide, N-oxydiethylene-thiocarbamyl-N-oxydiethylene sulfenamide, N-oxyethylene-2-benzothiazole sulfenamide and N, N′-diisopropyl-2-benzothiazole sulfenamide; guanidine-type vulcanization accelerators such as diphenylguanidine, di-o-tolylguanidine and di-o-tolylbiguanidine; thiourea-type vulcanization accelerators such as thiocarboanilide, di-o-tolylthiourea, ethylenethiourea, diethylenethiourea, dibutylthiourea and trimethylthiourea; thiazole-type vulcanization accelerators such as 2-mercaptobenzothiazole, dibenzothiazyl disulfide, 2-mercaptobenzothiazole zinc salt, 2-mercaptobenzothiazole sodium salt, 2-mercaptobenzothiazole cyclohexylamine salt, 4-morpholinyl-2-benzothiazole disulfide and 2-(2,4-dinitrophenylthio)benzothiazole; thiadiazine-type vulcanization accelerators such as activated thiadiazine; thiuram-type vulcanization accelerators such as tetramethylthiuram monosulfide, tetramethylthiuram disulfide, tetraethylthiuram disulfide, tetrabutylthiuram disulfide and dipentamethylenethiuram tetrasulfide; dithiocarbamic acid-type vulcanization accelerators such as sodium dimethyldithiocarbamate, sodium diethyldithiocarbamate, sodium di-n-butyldithiocarbamate, lead dimethyldithiocarbamate, lead diamyldithiocarbamate, zinc diamyldithiocarbamate, zinc dimethyldithiocarbamate, zinc diethyldithiocarbamate, zinc di-n-butyldithiocarbamate, zinc pentamethylene dithiocarbamate, zinc ethylphenyldithiocarbamate, tellurium diethyldithiocarbamate, bismuth dimethyldithiocarbamate, selenium dimethyldithiocarbamate, selenium diethyldithiocarbamate, cadmium diethyldithiocarbamate, copper dimethyldithiocarbamate, iron dimethyldithiocarbamate, diethylamine diethyldithiocarbamate, piperidinium pentamethylene dithiocarbamate and pipecoline pentamethylene dithiocarbamate; xanthogenic acid-type vulcanization accelerators such as sodium isopropylxanthogenate, zinc isopropylxanthogenate and zinc butylxanthogenate; isophthalate-type vulcanization accelerators such as dimethylammonium hydrogen isophthalate; aldehyde amine-type vulcanization accelerators such as butyraldehyde-amine condensation products and butyraldehyde-monobutylamine condensation products; and mixtures thereof. The vulcanization accelerator can be present in an amount of from 0.01 to 1% or from 0.01 to 0.6% by weight, based on the weight of the asphalt compositions.

Antireversion agents can also be included to prevent reversion, i.e., an undesirable decrease in crosslink density. Suitable antireversion agents include zinc salts of aliphatic carboxylic acids, zinc salts of monocyclic aromatic acids, bismaleimides, biscitraconimides, bisitaconimides, aryl bis-citraconamic acids, bissuccinimides, and polymeric bissuccinimide polysulfides (e.g., N,N′-xylenedicitraconamides). The antireversion agent can be present in an amount of from 0.01 to 1% or from 0.01 to 0.6% by weight, based on the weight of the asphalt composition.

The asphalt compositions can include a solvent such as water to disperse or emulsify the polymer and/or the asphalt. The asphalt compositions can include water in an amount of 1% to 35%, 5% to 30%, or 5% to 25% by weight, based on the weight of the asphalt compositions.

The asphalt compositions can further include one or more additional additives. Suitable additional additives include chloride salts, thickeners, and fillers. Chloride salts can be added, for example to improve emulsifiability, in an amount of up to 1 part by weight. Suitable chloride salts include sodium chloride, potassium chloride, calcium chloride, aluminum chloride, or mixtures thereof. Thickeners can be added in an amount of 0.5 parts by weight or greater and can include associative thickeners, polyurethanes, alkali swellable latex thickeners, cellulose, cellulose derivatives, modified cellulose products, plant and vegetable gums, starches, alkyl amines, polyacrylic resins, carboxyvinyl resins, polyethylene maleic anhydrides, polysaccharides, acrylic copolymers, hydrated lime (such as cationic and/or nonionic lime), or mixtures thereof. In some embodiments, the asphalt compositions described herein do not include a thickener. Mineral fillers and/or pigments can include calcium carbonate (precipitated or ground), kaolin, clay, talc, diatomaceous earth, mica, barium sulfate, magnesium carbonate, vermiculite, graphite, carbon black, alumina, silicas (fumed or precipitated in powders or dispersions), colloidal silica, silica gel, titanium oxides (e.g., titanium dioxide), aluminum hydroxide, aluminum trihydrate, satine white, magnesium oxide, hydrated lime, limestone dust, Portland cement, silica, alum, fly ash, or mixtures thereof. Fillers such as mineral fillers and carbon black can be included in an amount of up to 5 parts by weight or up to 2 parts by weight.

The asphalt compositions can also include an aggregate. The aggregate can be of varying sizes as would be understood by those of skill in the art. Any aggregate that is traditionally employed in the production of bituminous paving compositions can be used, including dense-graded aggregate, gap-graded aggregate, open-graded aggregate, reclaimed asphalt pavement, and mixtures thereof. In some embodiments, the asphalt compositions can include an aggregate in an amount of 1% to 90% by weight, based on the weight of the asphalt composition. In some embodiments, the asphalt compositions can include an aggregate in an amount of 90% or less, 85% or less, 80% or less, 75% or less, 70% or less, 65% or less, 60% or less, 55% or less, 50% or less, or 45% or less by weight, based on the weight of the asphalt composition. In some embodiments, the asphalt compositions can include an aggregate in an amount of 5% or greater, 10% or greater, 15% or greater, 20% or greater, 25% or greater, 30% or greater, 35% or greater, 40% or greater, 45% or greater, or 50% or greater by weight, based on the weight of the asphalt composition.

In some embodiments, the asphalt compositions can have a pH of 7 or less. For example, the asphalt composition can have a pH of 6.5 or less, 6 or less, 5.5 or less, 5 or less 4.5 or less 4 or less, 3.5 or less, 3 or less, or 2.5 or less. In some examples, the asphalt composition can have a pH of 1.5 or greater, 2 or greater, 2.5 or greater, 3 or greater, 3.5 or greater, 4 or greater, 4.5 or greater, 5 or greater, 5.5 or greater, 6 or greater, 6.5 or greater, or 7 or greater. In some embodiments, the asphalt composition can have a pH of from 1.5 to 7, from 2 to 6.5, from 1.5 to 6, from 2 to 6, from 3 to 7, from 3 to 6.5, from 3 to 6, from 4 to 7, from 4 to 6.5, or from 4 to 6.

Methods

Methods for preparing the asphalt compositions described herein are also provided. In some embodiments, the method can include preparing a latex composition of the polymer. A latex composition can be prepared by polymerizing monomers, such as styrene monomers, butadiene monomers, and optionally additional monomers in an aqueous emulsion polymerization reaction at a suitable temperature. The polymerization can be carried out at low temperature (i.e., cold polymerization) or at high temperature method (i.e., hot polymerization). In some embodiments, polymerization can be carried out at low temperature such as 30° C. or less (for example from 2° C. to 30° C., 2° C. to 25° C., 5° C. to 30° C., or 5° C. to 25° C.). In some embodiments, polymerization can be carried out at high temperature such as from 40° C. or greater, 50° C. or greater, or 60° C. or greater. In some embodiments, the high temperature can be from 40° C. to 100° C., 40° C. to 95° C., or 50° C. to 90° C.

The polymerized polymer can be produced using either a continuous, semi-batch (semi-continuous) or batch process. In some examples, the polymer can be produced using a continuous method by continuously feeding one or more monomer streams, a surfactant stream, and an initiator stream to one or more reactors. The surfactant stream includes a surfactant and water and can, in some embodiments, be combined with the initiator stream.

The polymerization reaction can be conducted in the presence of molecular weight regulators to reduce the molecular weight of the copolymer of other additives such as dispersants, stabilizers, chain transfer agents, buffering agents, salts, preservatives, fire retardants, wetting agents, protective colloids, biocides, crosslinking promoters, antioxidants, antiozonants, prevulcanization inhibitors, and lubricants. In some embodiments, the additives can be added to the latex composition after the polymerization reaction. The latex composition can be agglomerated, e.g., using chemical, freeze or pressure agglomeration, and water removed to produce the desired solids content. In some embodiments, the solids content is 55% or greater, 60% or greater, or 65% or greater.

In some embodiments, the latex composition can have an overall anionic charge, non-ionic, or cationic charge. One of ordinary skill in the art understands that the overall charge of the latex composition can be influenced by the surfactant used, the particular monomers used to form the polymer in the latex composition, and the pH of the latex composition. The charge of an anionic latex composition or a non-ionic latex composition can be “flipped” (modified) to an overall cationic charge, thereby forming a cationic latex composition. In some embodiments, the cationic latex composition can be formed by mixing the latex composition with an inorganic acid. For example, the method can include mixing the latex composition with phosphoric acid or hydrochloric acid to form the cationic latex composition. In some embodiments, the method can include mixing the latex composition with a sulfur curing agent.

In some embodiments, the method can include mixing the anionic, cationic, or nonionic latex composition with a basic salt, such as aluminum sulfate. In some embodiments, the method can include flipping the latex composition with an inorganic acid (such as phosphoric acid, hydrochloric acid, polyphosphoric acid, or mixtures thereof) prior to mixing with the basic salt. In certain embodiments, the latex composition does not include a basic salt, such as aluminum sulfate. In certain embodiments, the latex composition does not include phosphoric acid.

The latex compositions can be used in asphalt compositions prepared at temperatures below 120° C. (e.g., from 5° C. to less than 100° C., from 10° C. to 90° C., or from 20° C. to 85° C.). In some embodiments, the cationic latex compositions can be used in asphalt emulsions prepared less than 100° C., e.g., at ambient temperature, to produce a polymer-modified asphalt emulsion.

The method of preparing the asphalt emulsions can include contacting asphalt with a latex composition as described herein. In some embodiments, the latex composition is cationic. The method can further include contacting the asphalt with a basic salt, such as aluminum sulfate. In some embodiments, the method can further include contacting the asphalt with a sulfur curing agent. The particular components, including the asphalt, the latex composition, the sulfur curing agent, and the basic salt in the asphalt emulsions can be mixed together by any means known in the art. The particular components can be mixed together in any order.

The particular components, including the asphalt, the latex composition, and the asphalt can be fed into a colloid mill at a temperature of less than 100° C. (e.g., 60° C. to 95° C.) where high shear mixing produces an asphalt emulsion having asphalt droplets dispersed in the water. The sulfur curing agent and/or the basic salt can be added simultaneously or the sulfur curing agent and/or basic salt post-added to the asphalt emulsion (comprising the latex composition and asphalt). In some embodiments, the latex composition and the basic salt are mixed with the asphalt simultaneously. For example, the latex composition can include the basic salt such that the polymer, inorganic acid (if present), and the basic salt are simultaneously mixed with the asphalt. In some embodiments, the basic salt can be combined directly with the asphalt prior to mixing with the other ingredients. In some embodiments, the latex composition and the sulfur curing agent are mixed with the asphalt simultaneously. For example, the latex composition can include the sulfur curing agent such that the polymer, inorganic acid (if present), and the sulfur curing agent are simultaneously mixed with the asphalt. In some embodiments, the sulfur curing agent can be combined directly with the asphalt prior to mixing with the other ingredients.

The droplets in the asphalt emulsion can have a narrow particle size distribution. In some embodiments, the droplets in the asphalt emulsion can have a median particle size of 15 μm or less, 14 μm or less, 13 μm or less, 12 μm or less, 11 μm or less, 10 μm or less, 9 μm or less, 8 μm or less, 7 μm or less, 6 μm or less, or 5 μm or less and/or of 5 μm or greater, 6 μm or greater, 7 μm or greater, 8 μm or greater, 9 μm or greater, or 10 μm or greater. In some embodiments, the droplets in the asphalt emulsion can have a mean particle size of 15 μm or less, 14 μm or less, 13 μm or less, 12 μm or less, 11 μm or less, 10 μm or less, 9 μm or less, 8 μm or less, 7 μm or less, 6 μm or less, or 5 μm or less and/or of 5 μm or greater, 6 μm or greater, 7 μm or greater, 8 μm or greater, 9 μm or greater, or 10 μm or greater. In some embodiments, the droplets in the asphalt emulsion can have a median particle size of from 3 to 15 μm. In some embodiments, the droplets in the asphalt emulsion can have a median distribution of droplet particles having a standard deviation of from 3 to 30 μm. In some embodiments, the droplets in the asphalt emulsion can have a standard deviation of 30 μm or less, 25 μm or less, 20 μm or less, 15 μm or less, 10 μm or less, or 5 μm or less, and/or of 3 μm or greater, 5 μm or greater, 7 μm or greater, 8 μm or greater, 9 μm or greater, 10 μm or greater, 15 μm or greater, 20 μm or greater, or 25 μm or greater. In some embodiments, the droplets in the asphalt emulsion can have a median distribution of droplet particles having a standard deviation of less than 30%, less than 25%, less than 20%, less than 15%, or less than 10%. In some embodiments, the droplets in the asphalt emulsions comprising the phosphoric acid flipped cationic latex composition and/or aluminum sulfate can have a narrower particle size distribution than an asphalt emulsion that does not include the phosphoric acid flipped cationic latex composition and/or aluminum sulfate.

The asphalt emulsions can have a viscosity of 100 cp or greater, when the asphalt is present in an amount of 65% by weight, based on the asphalt emulsion, in the absence of a thickener. In the event the asphalt content is less than or greater than 65% by weight, the asphalt content can be adjusted by adding or removing water. In some embodiments, the asphalt emulsions can have a viscosity of 150 cp or greater, 200 cp or greater, 250 cp or greater, 300 cp or greater, 350 cp or greater, 400 cp or greater, 450 cp or greater, 500 cp or greater, 600 cp or greater, 700 cp or greater, 800 cp or greater, 900 cp or greater, 1000 cp or greater, 1500 cp or greater, 2000 cp or greater, or 2500 cp or greater, at 60° C. as determined by Brookfield viscometer, spindle#3 and 20 rpm, when the asphalt is present in an amount of 65% by weight, based on the asphalt emulsion. In some embodiments, the asphalt emulsions can have a viscosity of 2500 cp or less, 2000 cp or less, 1500 cp or less, 1250 cp or less, 1000 cp or less, 950 cp or less, 900 cp or less, 850 cp or less, 800 cp or less, 750 cp or less, 700 cp or less, 650 cp or less, 600 cp or less, 550 cp or less, 500 cp or less, 400 cp or less, 250 cp or greater, 300 cp or less, or 200 cp or less, at 60° C. as determined by Brookfield viscometer, spindle#3 and 20 rpm, when the asphalt is present in an amount of 65% by weight, based on the asphalt emulsion. In some embodiments, the viscosity of the asphalt emulsions can be from 100 cp to 2500 cp, for example, 100 cp to 1500 cp, 100 cp to 1000 cp, 100 cp to 800 cp, 100 cp to 600 cp, 100 cp to 500 cp, 200 cp to 1500 cp, 200 cp to 1000 cp, 200 cp to 800 cp, 200 cp to 600 cp, 200 cp to 500 cp, 100 cp to 500 cp, 100 cp to 450 cp, or 150 cp to 500 cp, at 60° C. as determined by Brookfield viscometer, spindle#3 and 20 rpm, when the asphalt is present in an amount of 65% by weight, based on the asphalt emulsion. In some embodiments, the addition of the phosphoric acid flipped cationic latex composition and/or aluminum sulfate to the asphalt emulsions can result in an increase in viscosity of 1 time or greater, 2 times or greater, 3 times or greater, 4 times or greater, 5 times or greater, 6 times or greater, or up to 10 times or greater, compared to an asphalt emulsion without the phosphoric acid flipped cationic latex composition and/or aluminum sulfate.

In some embodiments, the (polymer-modified) asphalt emulsion has a softening point that is 5° C. or greater, 10° C. or greater, or 15° C. or greater than the softening point of the same asphalt emulsion without the phosphoric acid. In some embodiments, the asphalt emulsion using a PG 58-28 base asphalt can have a softening point of 65° C. or greater (for example, 70° C. or greater, 75° C. or greater, or 80° C. or greater). In some embodiments, the asphalt emulsion using a PG 58-28 base asphalt can have a softening point of 85° C. or less (for example, 80° C. or less, 75° C. or less, or 70° C. or less). In some embodiments, the asphalt emulsion using a PG 58-28 base asphalt can have a softening point of from 65° C. to 85° C. or from 70° C. to 80° C. The Ring and Ball Softening Point test, such as those described in ASTM D36 and/or AASHTO T53, can be used to measure the temperature at which an asphalt composition becomes soft and flowable.

The asphalt emulsions described herein can adhere to the standards of ASTM D977, ASTM D2397, AASHTO M140, and AASHTO M208.

The latex composition can be used to prepare polymer modified hot mix asphalt compositions. A hot mix asphalt can be prepared, for example, by blending asphalt, a latex composition as described herein, and optionally a basic salt at a blending temperature exceeding the boiling point of water. In some embodiments, the latex composition can have a pH of 7 or less as described herein. In some embodiments, the latex composition can be anionic. For example, the latex composition can include a carboxylated polymer. In some embodiments, the latex composition can be nonionic. In some embodiments, the latex composition can be cationic, for example, by including a cationic surfactant. The blending temperature of the hot mix asphalt can be 150° C. or greater or 160° C. or greater and 200° C. or less. The hot mix asphalt composition is substantially free of water and can have, for example, a viscosity of 3000 cp or less, 2500 cp or less, 2000 cp or less, or 1500 cp or less at 135° C., at 60° C. as determined by Brookfield viscometer, spindle#3 and 20 rpm, when the asphalt is present in an amount of 95% by weight, based on the hot mix asphalt compositions. In some embodiments, the hot-mix asphalt composition can have a viscosity of 1000 cp or greater, 1250 cp or greater, 1500 cp or greater, 2000 cp or greater, or 2500 cp or greater, at 60° C. as determined by Brookfield viscometer, spindle#3 and 20 rpm, when the asphalt is present in an amount of 95% by weight, based on the hot mix asphalt compositions. In some embodiments, the viscosity of the hot-mix asphalt composition can be from 1000 cp to 3000 cp, for example, 1000 cp to 2500 cp, 1000 cp to 2000 cp, 1500 cp to 2500 cp, or 1500 cp to 2000 cp, at 60° C. as determined by Brookfield viscometer, spindle#3 and 20 rpm, when the asphalt is present in an amount of 95% by weight, based on the hot mix asphalt compositions. The latex composition can be in the amounts described above when added to the hot mix asphalt, but the resulting hot mix asphalt will include less of the latex composition because the water is evaporated leaving the latex polymer and any other non-volatile additives. For example, the latex polymer can be present in a hot mix asphalt compositions in an amount of from 0.05 wt % to 10 wt % (e.g., from 0.5 wt % to 3 wt %), based on the weight of the hot mix asphalt composition. In some embodiments, the hot mix asphalt composition has a pH of 7 or less, or 6 or less (e.g., 1.5 to 6), as described herein.

In some embodiments, the hot mix asphalt composition has a softening point that is 5° C. or greater, 10° C. or greater, or 15° C. or greater than the softening point of the same hot mix asphalt composition without the phosphoric acid. In some embodiments, the hot mix asphalt compositions can have a softening point of 75° C. or greater or 80° C. or greater using a PG 58-28 base asphalt.

Without wishing to be bound by theory, it is believed that the use of phosphoric acid as a flipping agent to convert the latex composition from anionic or non-ionic to cationic results in higher asphalt emulsion viscosity due to narrow emulsion droplet size distribution. In some embodiments, with or without breaking agents, such as aluminum sulfate, improved sweep performance can be achieved, even at lower asphalt residue levels, when phosphoric acid rather than hydrochloric acid is used as the flipping agent for the polymer.

The asphalt compositions described herein can have increased drying times. Without wishing to be bound by any theory, it is believed that aluminum sulfate, for example, due to its basic nature can destabilize cationic emulsions which may be acidic. A possible mechanism includes the destabilization of the amine surfactant by deprotonation, i.e., the amine losses its positive charge as the pH is raised by the application of the basic solution. Because of the destabilization brought about by aluminum sulfate, the emulsion breaks and sets earlier, resulting in faster drying and binder cohesion development and adhesion to aggregates and the underlying surface. Further, both the asphalt emulsion viscosity and the sweep performance increases due to the faster drying of the emulsion brought about by the asphalt droplet destabilization. Increased drying times of the asphalt emulsion can be confirmed by measuring the water loss in the sweep performance test. The sweep performance of the asphalt emulsion can be determined according to ASTM 7000.

Methods of using the asphalt compositions described herein are disclosed. The asphalt compositions can be applied to a surface to be treated, restored, or sealed. Prior to application of the asphalt composition, the surface to be treated is usually cleaned to remove excess surface dirt, weeds, and contaminants by, for example, brushing the surface, blasting the surface with compressed air, or washing the surface. The asphalt compositions can be applied using any suitable method for applying a liquid to a porous surface, such as brushing, wiping and drawing, or spraying.

In some embodiments, the asphalt compositions, once applied, wet the surface thereby forming a layer on at least a portion and typically at least a substantial portion (e.g. more than 50%) of the surface. In some embodiments, when asphalt emulsions are applied to a surface, water loss occurs in the emulsion, primarily due to adsorption of the water. The water also delivers the asphalt and the cationic latex composition to the surface. In some embodiments, the asphalt emulsion penetrates and adheres to the surface it is applied to, cures in a reasonably rapid time, and provides a water-tight and air-tight barrier on the surface. The asphalt emulsion layer also promotes adhesion between the older surface and the later applied surface treatment layer. It is desirable for the asphalt compositions to be easily applied and have an adequate shelf life.

An aggregate can be blended into the asphalt compositions before application to a surface. In some embodiments, the aggregate can be applied to the asphalt compositions after it is applied to a surface. For example, sand can be applied to the asphalt compositions after it is applied to a surface, for example, if the composition is to be used as a tack coat, to reduce the tackiness of the surface. The asphalt compositions and optionally the aggregate can be compacted after application to the surface as would be understood by those of skill in the art.

The asphalt compositions can be applied for use in a pavement or paved surface. A pavement surface or a paved surface is a hard surface that can bear pedestrian or vehicular travel can include surfaces such as motorways/roads, parking lots, bridges/overpasses, runways, driveways, vehicular paths, running paths, walkways, and the like. The asphalt compositions can be applied directly to an existing paved surface or can be applied to an unpaved surface. In some embodiments, the asphalt compositions can be applied to an existing paved layer as a tie layer, and a new layer comprising asphalt such as a hot mix layer is applied to the tie layer. The asphalt compositions can be applied to a surface “cold,” i.e., at a temperature below 40° C., or can be applied to at an elevated temperature, for example, from 50° C. to 120° C., from 55° C. to 100° C., or from 60° C. to 80° C.

In some embodiments, the asphalt compositions can be used as a tack coat or coating. The tack coat is a very light spray application of diluted asphalt emulsion that can be used to promote a bond between an existing surface and the new asphalt application. The tack coat acts to provide a degree of adhesion or bonding between asphalt layers, and in some instances, can fuse the layers together. The tack coat also acts to reduce slippage and sliding of the layers relative to other layers in the pavement structure during use or due to wear and weathering of the pavement structure. In some embodiments, the asphalt compositions can be applied to an existing paved layer (such as a hot-mix layer) as a tack coat, and a new layer comprising asphalt such as a hot-mix layer can be applied to the tack coat. As would be understood by those skilled in the art, the tack coat typically does not include aggregate, although sand may be applied to the tack coat after application as mentioned herein.

As described herein, the asphalt compositions cure/dry quickly. For example, where the asphalt compositions are used as a tack coating, the coating cures quickly such that a pavement layer may be applied to the coating, hours to days after the emulsion is applied to the substrate. In some embodiments, the applied composition can cure in 15 minutes to 45 minutes, and may cure as rapidly as less than 1 minute to 15 minutes after the composition is applied to the exposed surface. The cure rate will depend on the application rate, the dilution ratios used, the base course conditions, the weather, and other similar considerations. If the prepared pavement surface or base course contains excess moisture, the curing time of the asphalt compositions may be increased.

In some embodiments, the asphalt compositions can also be used as a fog seal. A fog seal is a surface treatment that applies a light application of the composition to an existing paved surface such as a parking lot to provide an enriched pavement surface that looks fresh and black. In some embodiments, the fog seal would include a filler such as carbon black to blacken the composition. As would be understood by those skilled in the art, the fog seal might not include aggregate. The fog seal compositions, like the bond coat compositions, have also been shown to be to be low-tracking or “trackless” coatings.

In some embodiments, the asphalt compositions can be used as a chip seal composition. Chip seals are the most common surface treatment for low-volume roads. The chip seal composition can be applied to a surface followed by the application of aggregate. In some embodiments, the asphalt compositions can be used in a microsurfacing application. Microsurfacing is designed for quick traffic return with the capacity of handling high traffic volume roadways. For the microsurfacing composition, aggregate can be mixed in with the cationic asphalt composition before application to a surface.

In some embodiments, the asphalt compositions can be used in paints, coatings, paper coating or binding compositions, carpet compositions (e.g., carpet backing), foams, or adhesives.

By way of non-limiting illustration, examples of certain embodiments of the present disclosure are given below.

### EXAMPLES

The following examples are put forth so as to provide those of ordinary skill in the art with a complete disclosure and description of how the compositions and/or methods claimed herein are made and evaluated, and are intended to be purely exemplary and are not intended to limit the scope of the disclosure. Unless indicated otherwise, parts are parts by weight, temperature is in ° C. or is at ambient temperature, and pressure is at or near atmospheric.

### Example 1

Preparation of Asphalt Emulsions

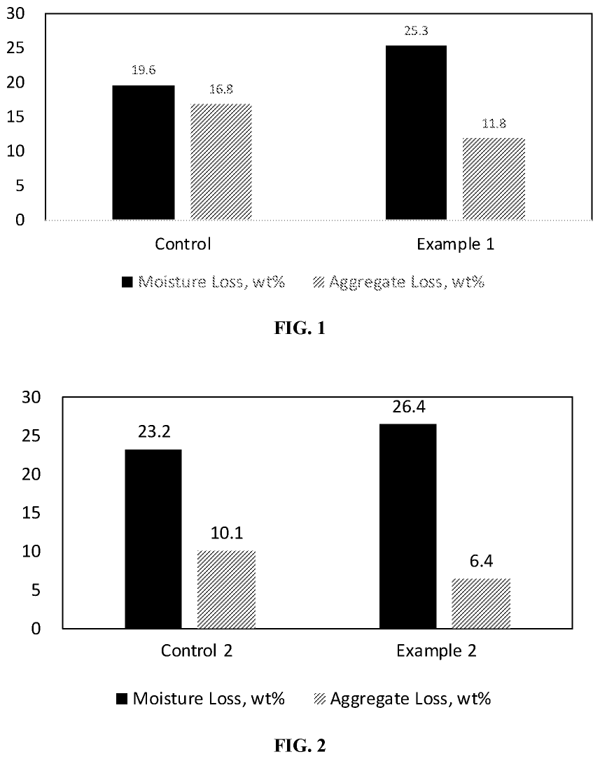

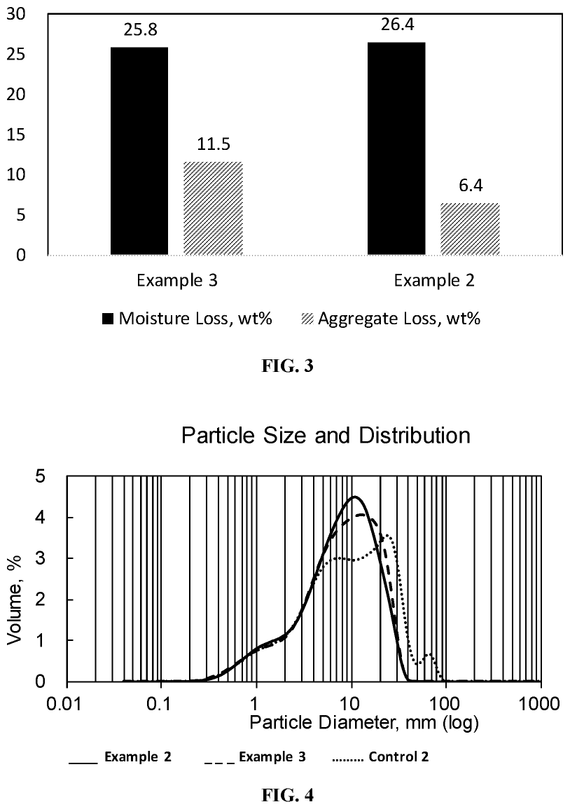

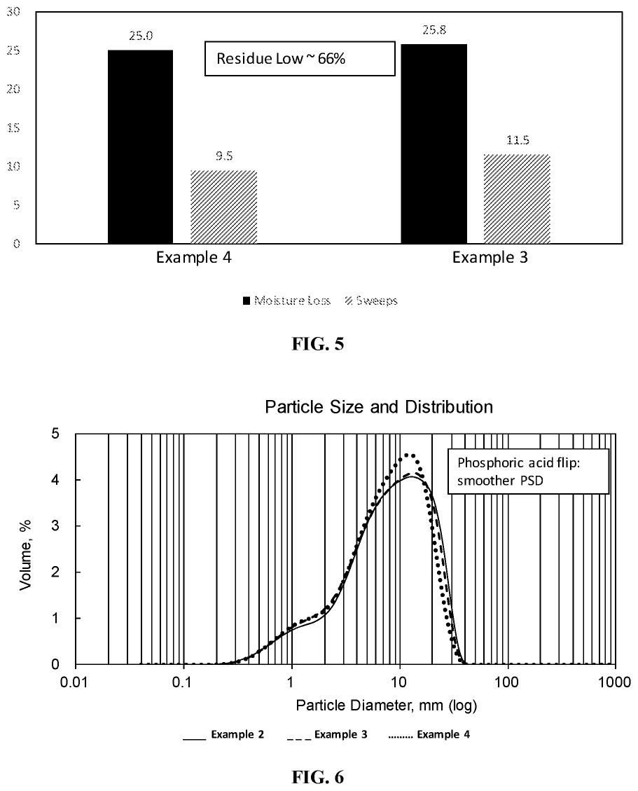

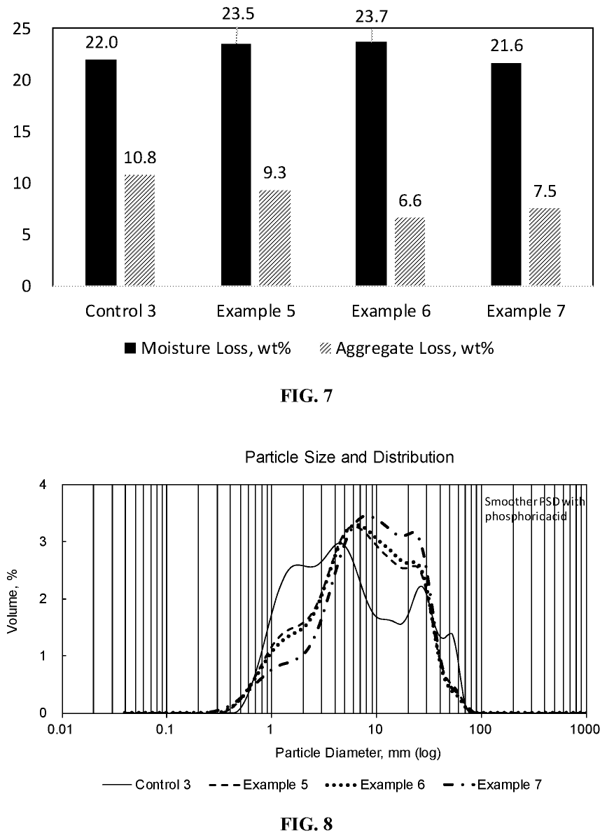

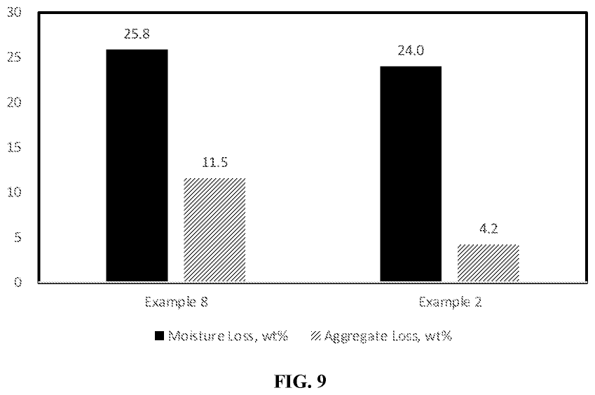

A cationic styrene-butadiene latex composition was prepared by mixing an inorganic acid and/or aluminum sulfate with a styrene-butadiene latex. Optionally, the styrene-butadiene latex was ‘flipped’ with hydrochloric acid or phosphoric acid. In some examples, aluminum sulfate was added to the cationic latex composition. The cationic latex composition and molten asphalt were pumped into a colloid mill where high shear mixing produces an asphalt emulsion having asphalt droplets dispersed in the water. The polymer amounts are based on asphalt solids and the other components are based on latex polymer solids. The amounts of each ingredient are given in Table 1. The viscosity and particle size of the asphalt emulsions were determined. The standard deviations were calculated. The results are summarized in Table 1. Graphs showing the moisture loss and aggregate loss as well as the particle size distribution of the asphalt emulsions are shown in FIGS. 1-9.

TABLE 1
Properties of particles in asphalt emulsions.

| | | | | | | | Particle | |
|---|---|---|---|---|---|---|---|---|
| | | | | | Mean | Median | Size | |
| | | | | | Particle | Particle | Standard | Cationic |
| | Al₂SO₄ | Acid | Asphalt | Viscosity cp | Size | Size | Deviation | surfactant |
| Sample | (wt %) | (wt %) | (wt %) | (spd 3/rpm 20) | (μm) | (μm) | (μm) | (wt %) |
| Control | — | 0.38 HCl | 69 | 145 | 20.9 | 9.04 | 23.9 | 4 |
| Control 2 | — | 0.38 HCl | 69 | 350 | 14.68 | 9.95 | 14.4 | 4 |
| Control 3 | — | 0.38 HCl | 67.7 | 90 | 11.94 | 5.16 | 14.69 | 4 |
| Ex 1 | 0.5 | 0.38 HCl | 69 | 245 | 9.89 | 7.67 | 7.87 | 4 |
| Ex 2 | — | 0.84 H₃PO₄ | 65.7 | 350 | 10.74 | 8.78 | 8.01 | 4 |
| Ex 3 | 1.5 | 0.84 H₃PO₄ | 65.3 | 310 | 10.18 | 8.49 | 7.59 | 4 |
| Ex 4 | | 0.84 H₃PO₄ | 65.9 | 330 | 10.23 | 8.41 | 7.6 | 3.5 |
| Ex 5 | | 0.84 H₃PO₄ | 67.87 | 120 | 11.81 | 11.82 | 13.16 | 3.25 |
| Ex 6 | | 0.84 H₃PO₄ | 68.45 | 140 | 7.37 | 7.66 | 9.2 | 3.5 |
| Ex 7 | | 0.84 H₃PO₄ | 68.48 | 140 | 12.02 | 11.62 | 12.09 | 4 |
| Ex 8 | | 0.84 H₃PO₄ + | 69 | 255 | 12.31 | 10.26 | 10.74 | 3 |
| | | 1.5 PPA | | | | | | |

PPA is polyphosphoric acid.

As shown in Table 1, there was a decrease in the particle size and the particle size distribution was narrower for the asphalt emulsions modified with the phosphoric acid flipped cationic latex composition and/or aluminum sulfate compared to the asphalt emulsions that were not modified with the phosphoric acid flipped cationic latex compositions and/or aluminum sulfate.

The compositions and methods of the appended claims are not limited in scope by the specific compositions and methods described herein, which are intended as illustrations of a few aspects of the claims and any compositions and methods that are functionally equivalent are intended to fall within the scope of the claims. Various modifications of the compositions and methods in addition to those shown and described herein are intended to fall within the scope of the appended claims. Further, while only certain representative materials and method steps disclosed herein are specifically described, other combinations of the materials and method steps also are intended to fall within the scope of the appended claims, even if not specifically recited. Thus, a combination of steps, elements, components, or constituents may be explicitly mentioned herein; however, other combinations of steps, elements, components, and constituents are included, even though not explicitly stated.

1.-43. (canceled)

44. A cationic asphalt emulsion comprising,
a) asphalt in an amount of from 50 wt % to 95 wt %, based on the weight of the cationic asphalt emulsion,
b) a latex polymer,
c) phosphoric acid present in an amount of 0.1% by weight or less, based on the weight of the cationic asphalt emulsion, wherein the cationic asphalt emulsion does not include a thickener; and
d) water.

45. The cationic asphalt emulsion of claim 44, wherein the polymer is present in an amount of from 0.5 wt % to 10 wt %, based on the weight of the cationic asphalt emulsion.

46. The cationic asphalt emulsion of claim 44, wherein the latex polymer includes a polymer selected from styrene-butadiene copolymers, polychloroprene, styrene-butadiene-styrene copolymers, ethylene vinyl acetate copolymers, and combinations thereof.

47. The cationic asphalt emulsion of claim 44, further comprising aluminum sulfate.

48. The cationic asphalt emulsion of claim 44, wherein the cationic asphalt emulsion comprises droplets, wherein the droplets have a median particle size of from 3 to 15 μm and a standard deviation of from 3 to 30 μm.

49. The cationic asphalt emulsion of claim 44, wherein the cationic asphalt emulsion has a softening point that is 5° C. or greater compared to the softening point of the asphalt without phosphoric acid.

50. A method of coating a surface comprising applying a cationic asphalt composition of claim 44 to the surface.

51. A method of making a cationic asphalt emulsion comprising,
contacting an anionic or nonionic aqueous latex composition comprising a polymer with phosphoric acid to form a cationic latex composition, and
mixing the cationic latex composition, asphalt, and optionally water to form a mixture, wherein the mixture has a viscosity of 100 to 2500 cp at 60° C. using a Brookfield viscometer, spindle #3, at 20 rpm, when the mixture comprises an asphalt solids content of 65 wt %, based on the weight of the mixture, and
wherein the mixture does not comprise a thickener.

52. The method of claim 51, wherein the anionic or nonionic latex composition is a nonionic latex composition.

53. The method of claim 51, wherein the cationic latex composition further comprises a sulfur curing agent.

54. The method of claim 51, wherein the cationic asphalt emulsion comprises a basic salt.

55. The method of claim 51, wherein the basic salt includes aluminum sulfate.
